(19) United States
(12) Patent Application Publication
(10) Pub. No.: US 2005/0104950 A1
(43) Pub. Date: May 19, 2005

(54) Apparatus to control color registration and image density using a single mark and method using the same

(75) Inventor: Yoon-seop Eom, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/966,032

(22) Filed: Oct. 18, 2004

Related U.S. Application Data
(63) Continuation-in-part of application No. 10/232,314, filed on Sep. 3, 2002.

(30) Foreign Application Priority Data
Sep. 4, 2001 (KR) 2001-54151

(51) Int. Cl. B41J 2/385; G03G 15/01; G01D 18/00

(52) U.S. Cl. 347/116; 399/31; 399/301

(57) ABSTRACT

An apparatus to control color registration and image density using a single mark and method using the same. The image forming apparatus has an image carrying member for carrying thereon an image having a plurality of colors. The image carrying member is configured to move in a first direction substantially perpendicular to a second direction, and a plurality of color marks having different densities are placed on the image carrying member for controlling respective registrations and toner densities of the color marks. One of said color marks includes a polygon having a first side which is not parallel to said first and second directions.

### CROSS-REFERENCE TO RELATED APPLICATIONS

This application is a continuation in part of U.S. Ser. No. 10/232,314, filed Sep. 3, 2002, now pending, which claims the benefit of Korean Patent Application No. 2001-54151 filed Sep. 4, 2001, the disclosures of which are incorporated herein by reference.

### BACKGROUND OF THE INVENTION

1. Field of the Invention

The present invention relates to an apparatus to control color registration and image density in a printer, and a method of calculating color registration error and image density, and more particularly, to an apparatus to detect both color registration and image density using a single mark and a method using same.

2. Description of the Related Art

Image forming apparatuses such as printers and copy machines form a latent electrostatic image by charging a photoconductive member on a transfer belt and performing selective exposure by scanning a laser beam, develop the latent electrostatic image using colored toners and a developer unit, and transfer the developed latent electrostatic image to a recording medium by pressing and heating, thereby forming an image.

Generally, the colors of toners used in a developer unit are cyan (C), magenta (M), yellow (Y), and black (K). The four color toners are transferred such that the four colors overlap to form a complete image. To deliver high quality images, unit images of individual colors should be accurately superimposed. This superimposition of colors is referred to as color registration.

Color registration errors can arise from complex causes such as mismatch of the individual color units of the developer unit, errors in processing an optical lens, and motion errors of the transfer belt. Particularly, color registration error becomes a problem in an image forming apparatus having a serial (or tandem) structure including a plurality of developer units.

Color registration errors may have various causes in a laser scanning unit (LSU) and a belt drive mechanism, and during belt steering and the assembly process. A belt steering error arises from belt weaving or deformation of the belt unit. An error during the assembly process may arise during the assembly of photosensitive drums such as an OPC drum, and the assembly of the LSUs.

An error in the LSU arises from irregular laser scan speed, asynchronization of a polygon mirror (not shown), jitter in an LSU motor (not shown), nonparallel laser beams, and mismatch in bow between laser beams. Here, asynchronization of a polygon mirror may be caused by inaccurate manufacture or imbalance during horizontal rotation, and causes an error in a scanning line. When laser beams are not parallel due to misalignment or mismatch in laser beam bow, toners are developed in the form of a bow, so an error may occur.

An error which may occur in a belt and photosensitive drum drive mechanism arises from a change in the diameter of a roll due to temperature, a change in the linear velocity of the transfer belt due to load on the belt, a change in rotary speed due to load on the photosensitive drum, and irregular driving of a transfer belt drive roller.

Color registration errors have four types: X-offset, Y-offset, printing width error, and skew. X-offset arises in a scan direction in which an LSU scans its laser light onto a photoconductive member. Y-offset arises in a cross-scan direction in which the transfer belt moves. Printing width errors arise from a difference in width of an image area. Skew arises from displacement of a development line. In order to obtain high quality images using color registration, a sensor to detect color registration errors and a method of accurately calculating the errors are required.

FIG. 1 is a diagram of a color registration sensor and a mark pattern disclosed in U.S. Pat. No. 5,287,162. Referring to FIG. 1, a color registration mark pattern 13 in a chevrog shape is formed on a transfer belt (not shown). A split sensor 11 including two split cells 11a and 11b detects a beam reflected from the color registration mark pattern 13. A cross scan direction and a scan direction are also illustrated. Colors of the marks (y, m, k) are also illustrated.

In addition to color registration, i.e., arrangement of colors in juxtaposition, it is also necessary to appropriately adjust image density in order to obtain high quality images. However, a disadvantage of the mark pattern of FIG. 1 is that image density cannot be detected. Conventional apparatuses may radiate beams on a different type of mark to determine image density. For example, a rectangular mark with sides extending in the scan and sub-scan directions may be used, as shown in FIG. 2. However, this image density mark cannot be used to detect color registration errors. Thus, separate marks and possibly separate sensors must be provided for each of the color registration error and image density detection. This results in additional parts and additional time required to perform the detecting operations.

### SUMMARY OF THE INVENTION

Accordingly, it is an aspect of the present invention to provide a color registration and image density control apparatus capable of detecting color registration errors and image density using a same mark.

The foregoing and/or additional aspects and/or advantages of the invention will be set forth in part in the description which follows and, in part, will be obvious from the description, or may be learned by practice of the invention.

The foregoing and/or other aspects of the invention are achieved by providing in an image forming apparatus having an image carrying member for carrying thereon an image having a plurality of colors, said image carrying member being configured to move in a first direction substantially perpendicular to a second direction, a plurality of color marks having different densities being placed on said image carrying member for controlling respective registrations and toner densities of said plurality of color marks on said image carrying member, one of said color marks including a polygon having a first side which is not parallel to said first and second directions.

According to an aspect of the present invention, the marks are placed in margin areas of the image carrying member on opposite sides of the image carrying member.

According to another aspect of the present invention, the plurality of color marks includes a plurality of color marks having a same color and different densities in series.

According to another aspect of the present invention, the marks each further include a second side disposed relative to the first side in the first direction, and the apparatus further includes a control unit to determine an error of the image in the second direction by determining time intervals between the passing of the first and second sides of first and second ones of the marks on opposite sides of the image carrying member, and subtracting the determined time intervals.

According to another aspect of the present invention, the apparatus further includes a sensor to detect the marks, wherein a power of an output of the sensor rises as each of the marks approaches the sensor, remains constant as each of the marks passes the sensor, and falls as each of the marks moves away from the sensor, wherein a position of the mark W relative to the sensor is determined according to W=T_{width}/2, wherein T_{width} is a time between a middle time of the rising of the power of the output and a middle time of the falling of the power of the output.

According to another aspect of the present invention, the sensor includes an emitter to emit a beam on the marks to detect the marks, the beam having a spot size of less than 200 microns. The spot size may even be less than 100 microns.

According to another aspect of the-present invention, the apparatus further includes a Low Pass Filter to filter noise signals of the output of the sensor.

According to another aspect of the present invention, the apparatus is a tandem printer including a plurality of photosensitive drums to respectively form the plurality of colors of the image.

According to another aspect of the present invention, the polygon further includes a borderline at the first side, the borderline having a greater density than a non-borderline portion of the polygon.

According to another aspect of the present invention, the plurality of color marks includes a plurality of color marks having different colors and same densities in series.

According to another aspect of the present invention, the polygon is a trapezoid.

According to another aspect of the present invention, the polygon is a wedge.

According to another aspect of the present invention, said image forming apparatus further places a background toner pattern having a color other than black on the image carrying member, and the plurality of color marks comprise a mark having a black color.

According to another aspect of the present invention, said emitted beam has a singular wave.

According to another aspect of the present invention, said emitted beam is diffusely radiated.

The foregoing and/or other aspects of the invention are also achieved by providing an apparatus to control both of color registration and color toner density at the same time in a color image forming device, said color image forming device having an image carrying member to carry an image having a plurality of colors that moves in a first direction, and perpendicular to a second direction, the apparatus including a plurality of developing units to form a plurality of color marks formed of respective colors along said first direction, said color marks forming a closed area filled with said respective one of said plurality of colors and including a first side which is not parallel to said first and second directions, wherein said respective color toner densities of said plurality of color marks are different, a sensing unit including a sensor to radiate light beams onto said color marks, to receive said light beams reflected from said color marks and to produce detection signals in accordance with the received reflected light beams, and a control unit to produce color registration offset information and color density offset information from said detection signals

The foregoing and/or other aspects of the invention are also achieved by providing a method including moving an image carrying member to carry an image having a plurality of colors in a first direction; forming a plurality of polygons on the image carrying member including shading in the polygons with a toner; and sensing the polygons to determine an offset of the polygons in the first direction or a second direction perpendicular to the first direction, a skew of the polygons, or an error of the image in the second direction, the polygons including a first side which is not parallel to the first and second directions

The foregoing and/or other aspects of the invention are achieved by providing in an image forming apparatus having an image carrying member for carrying thereon an image having a plurality of colors, said image carrying member being configured to move in a first direction substantially perpendicular to a second direction, a plurality of color marks having different densities being placed on said image carrying member for controlling respective registrations and toner densities of said plurality of color marks on said image carrying member, one of said color marks including a polygon having first and second opposite sides which are not parallel to each other.

The foregoing and/or other aspects of the invention are also achieved by providing an apparatus to control both of color registration and color toner density at the same time in a color image forming device, said color image forming device having an image carrying member to carry an image having a plurality of colors that moves in a first direction, and perpendicular to a second direction, the apparatus including a plurality of developing units to form a plurality of color marks formed of respective colors along said first direction, said color marks forming a closed area filled with said respective one of said plurality of colors and including first and second opposite sides which are not parallel to each other, wherein said respective color toner densities of said plurality of color marks are different, a sensing unit including a sensor to radiate light beams onto said color marks, to receive said light beams reflected from said color marks and to produce detection signals in accordance with the received reflected light beams, and a control unit to produce color registration offset information and color density offset information from said detection signals.

The foregoing and/or other aspects of the invention are also achieved by providing a method including moving an image carrying member to carry an image having a plurality of colors in a first direction; forming a plurality of polygons on the image carrying member including shading in the polygons with a toner; and sensing the polygons to determine an offset of the polygons in the first direction or a second direction perpendicular to the first direction, a skew of the polygons, or an error of the image in the second direction, the polygons including first and second opposite sides which are not parallel to each other

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a diagram of a conventional color registration sensor and mark pattern;

FIG. 2 is a diagram of a conventional mark to detect image density;

FIG. 3 is a block diagram of an apparatus to control color registration and image density according to an embodiment of the present invention;

FIG. 4A illustrates the mark pattern of FIG. 3;

FIG. 4B illustrates another example of a mark according to the embodiment of the present invention;

FIG. 5 is a sectional view of a printer in which an apparatus to control color registration and image density according to the embodiment of the present invention is installed;

FIG. 6 is a sectional view of the optical module configuration of a registration and image density sensor used in the embodiment of FIG. 3;

FIG. 7 is a diagram of a beam radiated from the color registration sensor according to the present invention;

FIG. 8 is a schematic diagram of the scattered waveform of a beam which is detected by the color registration and image density sensor according to the present invention;

FIG. 9 is a diagram of signals produced with respect to marks of different colors and a same image density;

FIG. 10 shows offsets calculated by the color registration and image density sensor;

FIG. 11A shows an arrangement of the marks according to color and image density according to the embodiment of the present invention;

FIG. 11B shows another arrangement of the marks according to color and image density according to the embodiment of the present invention.

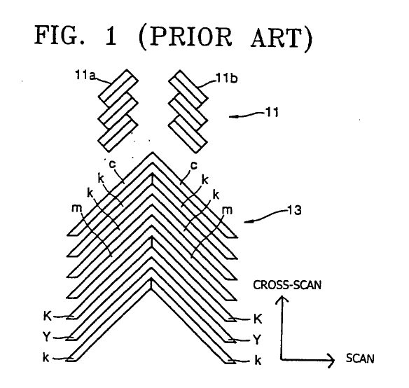

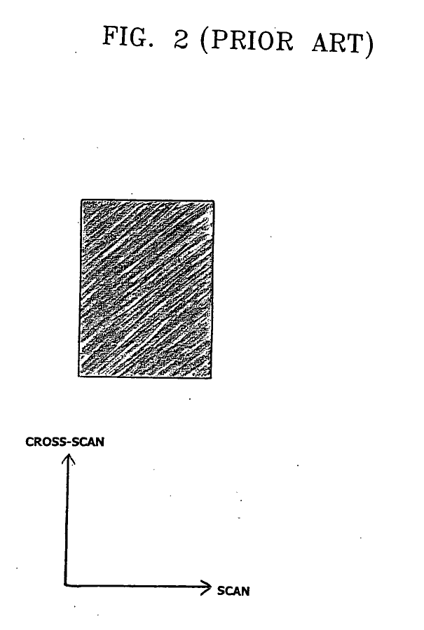

### DETAILED DESCRIPTION OF THE PREFERRED EMBODIMENT

Reference will now be made in detail to the present preferred embodiment of the present invention, an example of which is illustrated in the accompanying drawings, wherein like reference numerals refer to like elements throughout.

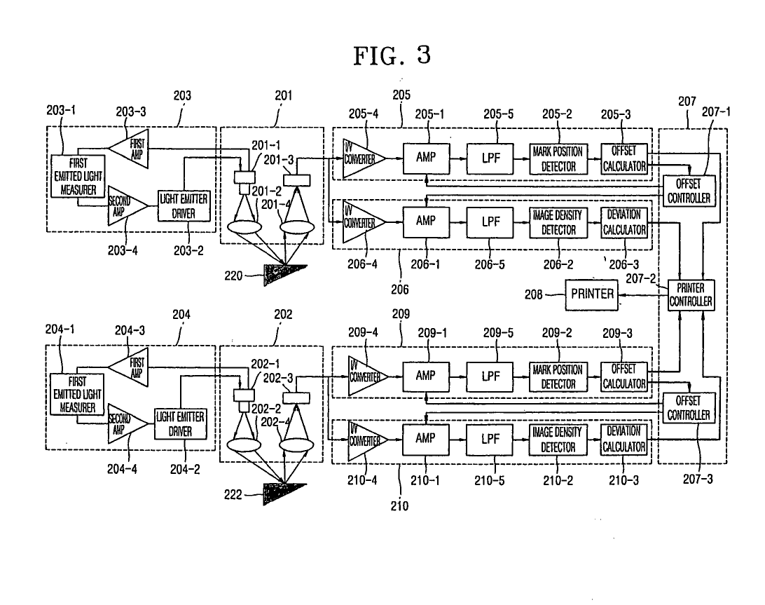

FIG. 3 is a block diagram of an apparatus to control color registration and image density according to an embodiment of the present invention. Referring to FIG. 3, the apparatus includes two color registration and image density sensors provided on the left and right sides and a pair of color registration and image density mark patterns (hereinafter “mark patterns” or individually as “marks”) provided on the left and right sides.

A first registration and image density sensor includes a first optical module 201, a first light emitter control unit 203, a first color registration control unit 205, a first image density control unit 206, and a system control unit 207. A second registration and image density sensor includes a second optical module 202, a second light emitter control unit 204, a second color registration control unit 209, a second image density control unit 210, and the system control unit 207.

The first and second optical modules 201 and 202 include light emitters to radiate beams onto first and second mark patterns 220 and 222, respectively, and light receivers to receive beams reflected from the first and second mark patterns 220 and 222, respectively. The light emitters include light sources 201-1 and 202-1, respectively, to generate and emit light beams, and focusing lenses 201-2 and 202-2, respectively, to focus the beams emitted from the respective light sources 201-1 and 202-1 onto the first and second mark patterns 220 and 222, respectively. Laser diodes are used as the light sources 201-1 and 202-1.

The light receivers include photodetectors 201-3 and 202-3, respectively, to receive the emitted beams and perform photoelectric conversion, and focusing lenses 201-4 and 202-4, respectively, to focus the light beams emitted from the respective light emitters and reflected from the respective first and second mark patterns 220 and 222 onto the photodetectors 201-3 and 202-3, respectively.

The first and second light emitter control units 203 and 204 detect the amount of light emitted from the respective light emitters and control the light emitters to maintain a constant emission. Each of the first and second light emitter control units 203 and 204 includes a first AMP 203-3 or 204-3 to amplify a signal representing the amount of light of beams emitted from the light source 201-1 or 202-1, and an emitted light measurer 203-1 or 204-1 to receive an output signal of the first AMP 203-3 or 204-3 and measure the amount of light emitted from each of the light emitters. The first and second light emitter control units 203 and 204 each further include a second AMP 203-4 or 204-4 to amplify an emitted light amount signal output from the emitted light measurer 203-1 or 204-1, and a light emitter driver 203-2 or 204-2 to receive the output signal of the second AMP 203-4 or 204-4 and to control the amount of light emitted from each of the light emitters.

Current signals produced by the respective light receivers are transmitted to the first and second color registration control units 205 and 209, respectively, and to the first and second image density control units 206 and 210, respectively. The first and second color registration control units 205 and 209 obtain information to compensate for color registration errors from the current signal produced by the respective light receivers.

The first and second color registration control units 205 and 209 include I/V converters 205-4 and 209-4 to convert the current signals produced by the respective light receivers into voltage signals, AMPs 205-1 and 209-1 to amplify the voltage signals from the respective I/V converters 205-4 and 209-4, LPFs (Low Pass Filters) 205-5 and 209-5 to pass only low frequency bands of the respective amplified signals, mark position detectors 205-2 and 209-2 to detect the positions of the first and second mark patterns 220 and 222 from signals received from the respective LPFs 205-5 and 209-5, and offset calculators 205-3 and 209-3 to calculate offsets from the values of the respective detected mark positions. Here, the offsets include information about X-offset, Y-offset, printing width error, and skew.

The first and second image density control units 206 and 210 include I/V converters 206-4 and 210-4 to convert the current signals produced by the respective light receivers into voltage signals, AMPs 206-1 and 210-1 to amplify the voltage signals from the respective I/V converters 206-4 and 210-4, LPFs 206-5 and 210-5 to pass only low frequency bands of the respective amplified signals, image density detectors 206-2 and 210-2 to detect image density attributes for different colors from output signals of the respective LPFs 206-5 and 210-5, and deviation calculators 206-3 and 210-3 to compare the detected image density attributes with reference image density attributes and to calculate the deviation.

The system control unit 207 includes a printer controller 207-2 to receive information to compensate for color registration error and image density error from the first and second color registration control units 205 and 209 and the first and second image density control units 206 and 210, and to control a printer 208, and an offset controller 207-1 to change the output values of the AMPs 205-1 and 206-1 to compensate for a difference in the amount of light of beams reflected from the first and second mark patterns 220 and 222. The system control unit 207 also includes an offset controller 207-3 to change the output values of the AMPs 209-1 and 210-1 to compensate for a difference in the amount of light of beams reflected from the first and second mark patterns 220 and 222.

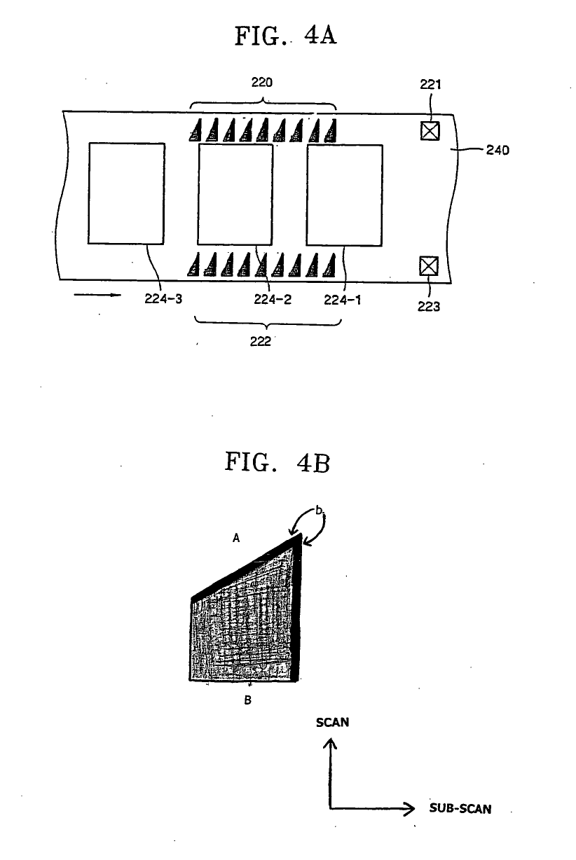

FIG. 4A shows the mark patterns 220, 222 of FIG. 3. Referring to FIG. 4A, first through third image areas 224-1, 224-2, and 224-3 are disposed in the middle of a transfer belt 240. The mark patterns 220, 222 are arranged in a cross-scan direction (indicated by the arrow) on each of the right and left sides of the transfer belt 240. The mark patterns 220, 222 are formed in margin areas of the transfer belt 240.

Each of the marks of the mark patterns 220, 222 is a shaded polygon having a side which is parallel to the scan direction, a side which is parallel to the sub-scan direction, and a slanting side which is not parallel to either of the scan or sub-scan directions. Although FIGS. 3 and 4A illustrate a wedge-shaped polygon, other shapes are also possible, provided there is at least one side which is not parallel to the scan or sub-scan directions. For example, FIG. 4B illustrates a trapezoid in which the opposite sides A and B are not parallel to each other, but side B is parallel to the sub-scan direction. FIG. 4B also illustrates borders ‘b’ having a greater density than other portions of the marks, to improve detection of the marks.

Color registration and image density sensors 221 and 223 are provided above the transfer belt 240. Each of the color registration and image density sensors 221 and 223 radiates a beam onto a portion of the mark patterns 220, 222 when the mark patterns 220, 222 pass the respective sensor 221 or 223 as the transfer belt 240 moves in the cross-scan direction and produces a detection signal.

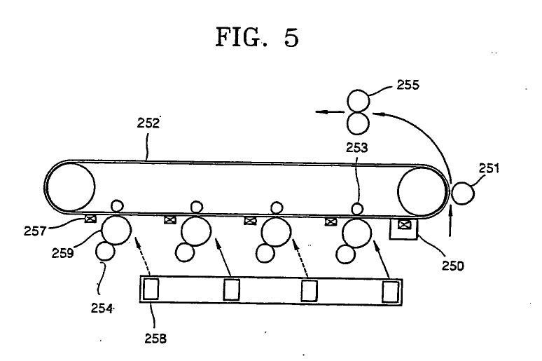

FIG. 5 is a sectional view of a printer in which an apparatus to control color registration and image density according to the embodiment of the present invention is installed. Referring to FIG. 5, a color registration and image density sensor 250 (identical to sensors 221 and 223) is provided between an LSU 258 and a transfer roll 251. A tof/weaving sensor 257 is provided between a charger (not shown) and the LSU 258. Here, reference numeral 253 denotes a belt drive roll, reference numeral 255 denotes a dry/fixing device, and reference numeral 252 denotes an intermediate transfer belt. Reference number 259 is a photosensitive drum to be scanned by the LSU 258 to form a latent electrostatic image thereon. The latent electrostatic image is then developed by developer transferred via developer roll 254. Each of the developer rolls 254 provides a different color developer, i.e., yellow, black, cyan and magenta. Thus a tandem-style printing apparatus is illustrated. However, this is just an example, and other style printers are possible.

In the case where a black mark is provided, a background toner pattern of a color other than black is provided.

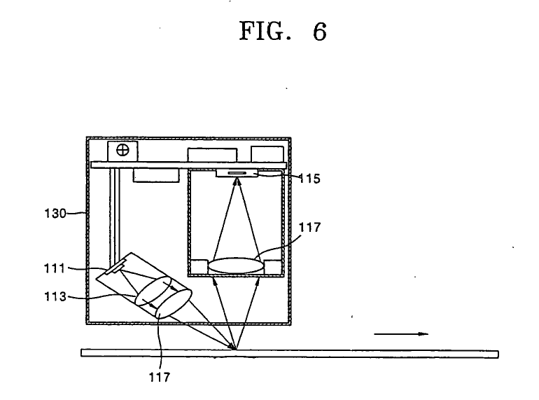

FIG. 6 is a sectional view of the optical module configuration of a color registration and image density sensor used in the embodiment of FIG. 3. Referring to FIG. 6, an optical module 130 is provided with a light emitter including a laser diode 111 as a light source and a focusing lens 117 to focus beams emitted from the laser diode 111 onto a mark of the mark patterns 220, 222. A collimating lens 113 to convert beams emitted from the laser diode 111 into parallel beams is further provided on the optical path between the laser diode 111 and the focusing lens 117. The laser diode 111 may not focus beams on the mark patterns 220, 222, but may diffusely radiate beams to detect beams reflected therefrom.

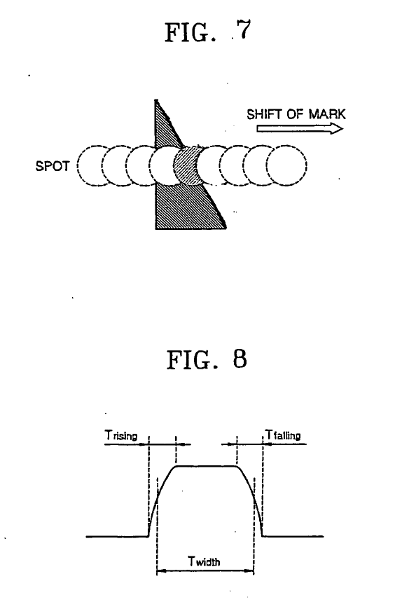

Referring to FIG. 7, a spot size of a beam radiated onto the marks is no greater than about 200 μm. If the size of the spot is decreased to 100 μm or less, detection performance can be improved. The sensor can be made more reliable if the beam is reflected only at a position where it meets the marks. In addition, errors caused by chromatic aberration can be reduced if the emitted beam has a single wavelength.

The optical module 130 further includes a light receiver including a photodetector 115 to receive beams reflected from the mark and perform photoelectric conversion, and a focusing lens 117 provided between the mark and the photodetector 115 to focus beams reflected from the mark onto the photodetector 115.

Referring to FIG. 7, when the mark shifts, the spot of the beam emitted from the light source shifts, as shown in the drawing. When the spot of the emitted beam is at the center of the mark, a maximum detection signal can be obtained. For optimum performance, the light receiver is designed to receive only beams diffusely reflected, rather than beams regularly reflected at an angle equal to the angle of incidence, thereby reducing detection error.

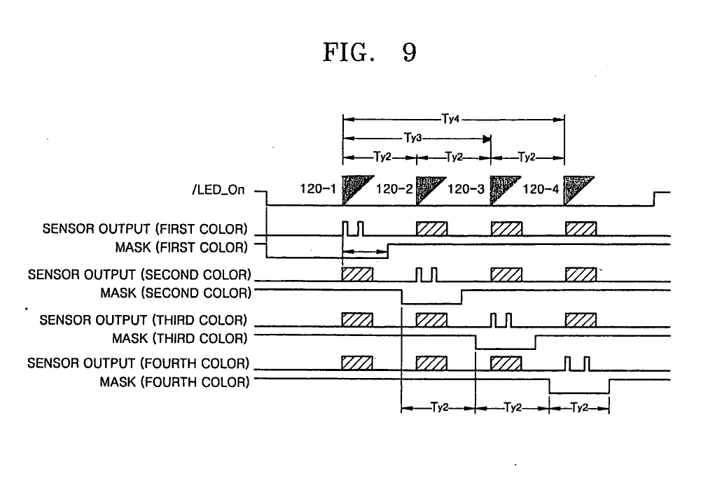

FIG. 8 is a diagram of a waveform of a beam detected by the color registration and image density sensor. FIG. 8 is provided to explain a method of detecting the position of a mark. Referring to FIG. 8, it can be seen from the waveform of a detection signal of beams reflected from a mark that the power of the detection signal output from a color registration and image density sensor rises as the mark on the transfer belt approaches the color registration and image density sensor, remains constant as the mark passes the center of the sensor, and gradually falls as the mark moves away from the sensor.

The time taken for the power to rise from the minimum to the maximum value is represented by T_{rising}, and the time taken for the power to fall from the maximum value to the minimum value is represented by T_{falling}. Times T_{rising} and T_{falling} depend on the spot size of the beam. As the spot size of the beam is smaller, times T_{rising} and T_{falling} decrease, so that a mark detection error decreases.

Here, the position W of the mark is determined by Formula (1). T_{width} indicates the time between the middle of the time T_{rising} and the middle of the time T_{falling}.
W=T_{width}/2 (1)

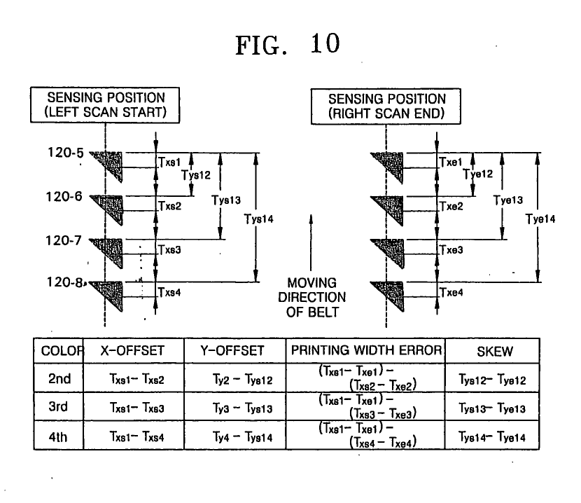

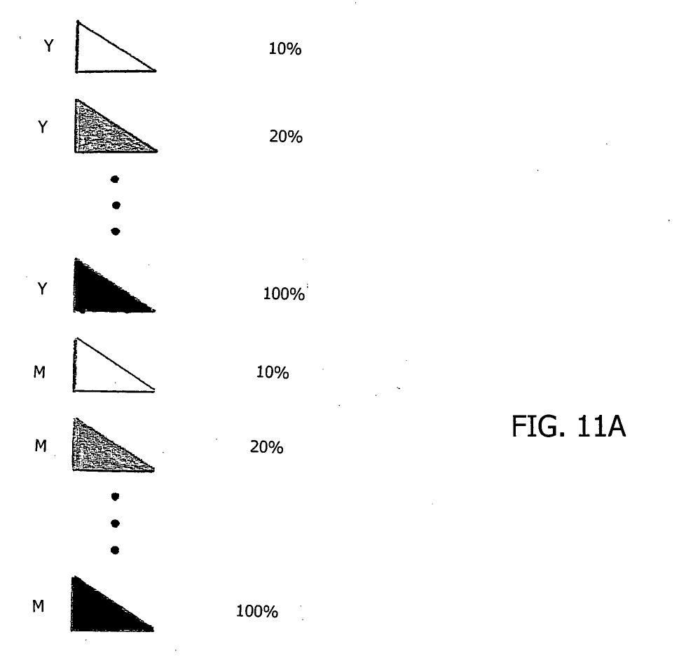

FIG. 9 is a diagram of signals produced with respect to marks of different colors and a same image density. Referring to FIG. 9, it can be seen from a graph of a first detection signal that the first detection signal output from the color registration and image density sensor includes a scan direction signal component and a slanting direction signal component respectively corresponding to a slanting side and a scan direction side of a first mark 120-1. Masking is performed to prevent signals of second through fourth marks 120-2, 120-3, and 120-4 from being produced. The graphs of second through fourth detection signals of the second through fourth marks can be explained in the same manner as the graph of the first detection signal. FIG. 10 shows the marks in pairs 120-5, 120-6, 120-7 and 120-8.

Here, T_{y2} indicates the time interval between the scan side of the first mark 120-1 and the scan side of the second mark 120-2. T_{y3} indicates the time interval between the scan side of the first mark 120-1 and the scan side of the third mark 120-3. T_{y4} indicates the time interval between the scan side of the first mark 120-1 and the scan side of the fourth mark 120-4.

X-offset, that is, scan direction error, with respect to the marks can be obtained from the differences between time intervals between the scan sides and the slanting sides of the respective marks.

An X-offset with respect to the second mark on the left side is expressed by Formula (2). Here, Tₓₛ₁ indicates the time interval between the scan side of the first mark on the left side and the slanting side thereof, and Tₓₛ₂, Tₓₛ₃, and Tₓₛ₄ indicate the same time interval with respect to the second, third and fourth marks, respectively, on the left side.
Tₓₛ₁−Tₓₛ₂ (2)

When Formula (2) gives a negative result, Tₓₛ₂ is greater than Tₓₛ₁, which means that the second mark on the left side is positioned further to the left than the first mark on the left side. In this case, scan direction error can be reduced by increasing the X-offset. When Formula (2) gives a positive result, Tₓₛ₂ is less than Tₓₛ₁, which means that the second mark on the left side is positioned further to the right than the first mark on the left side. In this case, scan direction error can be reduced by decreasing the X-offset.

X-offsets of the third and fourth marks on the left can be described in the same manner. The X-offset of the third mark on the left is expressed by Formula (3), and the X-offset of the fourth mark on the left is expressed by Formula (4).
Tₓₛ₁−Tₓₛ₃ (3)
Tₓₛ₁−Tₓₛ₄ (4)

The same principles can be applied to the second through fourth marks on the right.

Y-offset, that is, cross-scan direction error, of marks is calculated from the difference between predetermined time intervals between the scan sides of the respective marks arranged in a cross-scan direction and detected time intervals therebetween.

A Y-offset of the second mark on the left is the difference between T_{y2} (shown in FIG. 9) and T_{ys12} (shown in FIG. 10), and is expressed by Formula (5). Here, T_{ys12} indicates a detected time interval between the scan side of the first mark on the left and the scan side of the second mark on the left. T_{ys12} is a predetermined value, but T_{ys12} is a variable.
T_{y2}−T_{ys12} (5)

When the Y-offset is negative, T_{ys12} is greater than T_{yx2}, that is, the detected time interval is longer than the predetermined time interval. This means that a page is delayed. Accordingly, cross-scan direction error can be reduced by advancing the page. When the Y-offset is positive, it can be inferred that a page is advanced based on the above principle. Accordingly, cross-scan direction error can be reduced by delaying the page.

Y-offset of the third and fourth marks on the left can be described based on the same principles as described above. The Y-offset of the third mark on the left is expressed by Formula (6), and the Y-offset of the fourth mark on the left is expressed by Formula (7).
T_{y3}−T_{ys13} (6)
T_{y4}−T_{ysa4} (7)

The same principles can be applied to the second through fourth marks on the right.

Printing width error can be obtained from the difference between a first differential value and a second differential value. Each of the first and second differential values is the difference between the time interval between the scan side and the slanting side of a mark on the left, and the time interval between the scan side and the slanting side of a mark of the same color on the right.

A printing width error of the second mark pair 120-6 is expressed by Formula (8).
(Tₓₛ₁−Tₓₑ₁)−(Tₓₛ₂−Tₓₑ₂) (8)

When Formula (8) gives a negative result, the printing width between the second left and right marks is greater than the printing width between the first left and right marks. In this case, reduction of the printing width is required. When Formula (8) gives a positive result, the opposite is true. The same principles as described above can be applied to printing width errors of the third and fourth left and right marks. Here, Tₓₑ₁ indicates the detected time interval between the scan side and the slanting side of the first mark on the right, and Tₓₑ₂, Tₓₑ₃, and Tₓₑ₄ indicate the same time intervals with respect to the second through fourth marks on the right.

Printing width error of the third left and right marks is expressed by Formula (9), and printing width error of the fourth left and right marks is expressed by Formula (10).
(Tₓₛ₁−Tₓₑ₁)−(Tₓₛ₃−Tₓₑ₃) (9)
(Tₓₛ₁−Tₓₑ₁)−(Tₓₛ₄−Tₓₑ₄) (10)

Skew can be obtained from the difference between a detected time interval between the scan sides of two different marks arranged in a cross-scan direction on the left, and a detected time interval between the scan sides of corresponding two different marks arranged in a cross-scan direction on the right.

Skew with respect to the second left and right marks is expressed by Formula (11). Even when the above three kinds of errors do not arise, an error in a polygon mirror in an LSU (not shown) or a laser scan error may cause a scanning line to skew.
T_{ys12}−T_{ye12} (11)

When Formula (11) gives a negative result, T_{ye12} is greater than T_{ys12}, representing skew to the right. When Formula (11) gives a positive result, skew is to the left. Here, T_{ys12} indicates the time interval between the scan sides of the first and second marks on the left, T_{ye12} indicates the time interval between the scan sides of the first and second marks on the right, T_{ys13} indicates the time interval between the scan sides of the first and third marks on the left, T_{ye13} indicates the time interval between the scan sides of the first and third marks on the right, T_{ys14} indicates the time interval between the scan sides of the first and fourth marks on the left, and T_{ye14} indicates the time interval between the scan sides of the first and fourth marks on the right. Skew with respect to the third and fourth mark pairs 120-7 and 120-8 is expressed by Formula (12) and Formula (13), respectively.
T_{ys13}−T_{ye13} (12)
T_{ys14}−T_{ye14} (13)

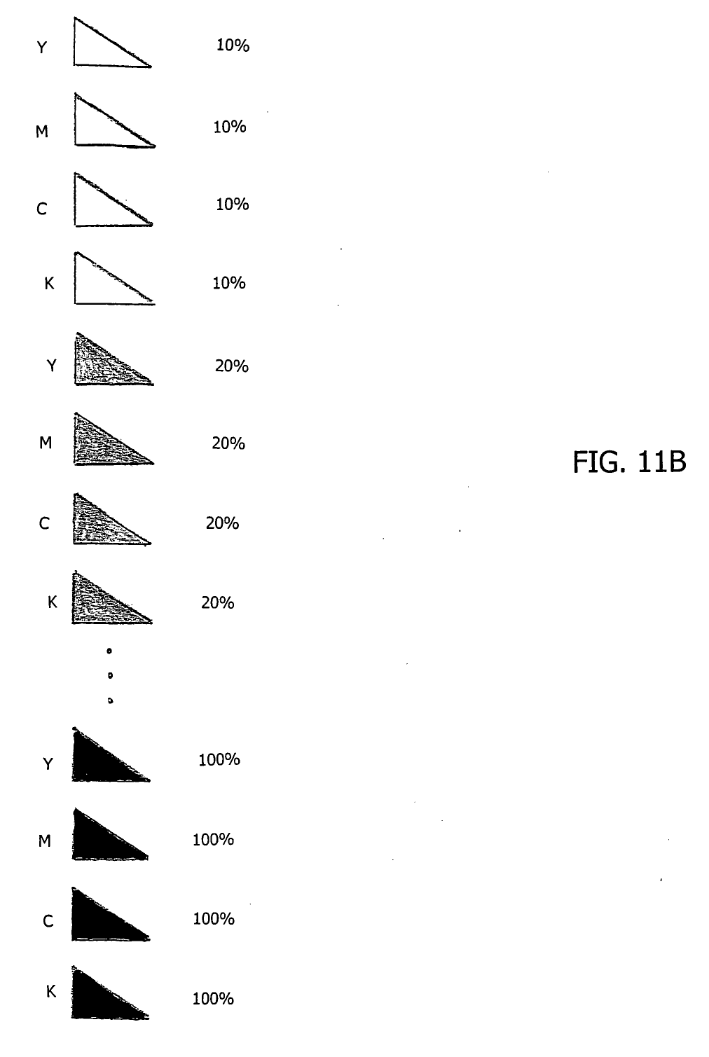

For determining image density, the marks having a grey level of 10% for first through fourth colors are arranged in line to thus form a unit set, and consecutively, a set of marks having a grey level of 20% for the first through fourth colors are arranged in line (see FIG. 11B). With such an arrangement, sets of image density marks for the first through fourth colors having grey levels of 10 through 100%, increasing in steps of 10%, are arranged. Alternatively, marks having a same color and varying image densities may be printed consecutively (see FIG. 11A). Although FIG. 11A only illustrates Y and M, this process is repeated for all colors. The power of the detection signals varies with the density of the image.

According to an apparatus to control color registration and image density and a method of calculating color registration error and image density error according to the embodiment of the present invention, color registration and image density can be detected using a single mark. X-offset, Y-offset, printing width error, skew and image density can be simultaneously detected and used to compensate for registration error.

Although a preferred embodiment of the present invention has been shown and described, it will be appreciated by those skilled in the art that changes may be made in this embodiment without departing from the principles and spirit of the invention, the scope of which is defined in the claims and their equivalents.

1. In an image forming apparatus having an image carrying member for carrying thereon an image having a plurality of colors, said image carrying member being configured to move in a first direction substantially perpendicular to a second direction, a plurality of color marks having different densities being placed on said image carrying member for controlling respective registrations and the toner densities of said plurality of color marks on said image carrying member, one of said color marks comprising:
a polygon having a first side which is not parallel to said first and second directions.

2. The apparatus of claim 1, wherein said image forming apparatus further places a background toner pattern having a color other than black on the image carrying member, and the plurality of color marks comprise a mark having a black color.

3. The apparatus of claim 1, wherein the color marks are placed in margin areas of the image carrying member on opposite sides of the image carrying member.

4. The apparatus of claim 1, wherein the plurality of color marks comprises a plurality of color marks having a same color and different densities in series.

5. The apparatus of claim 1, wherein the color marks each further comprise a second side disposed relative to the first side in the first direction, and the apparatus further comprises a control unit to determine an error of the image in the second direction by determining time intervals between the passing of the first and second sides of first and second ones of the color marks on opposite sides of the image carrying member, and subtracting the determined time intervals.

6. The apparatus of claim 1, wherein the apparatus further comprises a sensor to detect the color marks.

7. The apparatus of claim 6, wherein a power of an output of said sensor rises as the color marks respectively approach the sensor, remains constant as the color marks respectively pass the sensor, and falls as the color marks respectively move away from the sensor, wherein a position W of the respective color marks relative to the sensor is determined according to W=T_{width}/2, wherein T_{width} is a time between a middle time of the rising of the power of the respective output and a middle time of the falling of the power of the respective output.

8. The apparatus of claim 6, wherein the sensor comprises an emitter to emit a beam on the marks to detect the marks, the beam having a spot size of less than 200 microns.

9. The apparatus of claim 8, wherein said spot size is less than 100 microns.

10. The apparatus of claim 8, wherein said emitted beam has a singular wave.

11. The apparatus of claim 8, wherein said emitted beam is diffusely radiated.

12. The apparatus of claim 7, wherein the apparatus further comprises a Low Pass Filter to filter noise signals of the output of the sensor.

13. The apparatus of claim 1, wherein the apparatus is a tandem printer comprising a plurality of photosensitive drums to respectively form the plurality of colors of the image.

14. The apparatus of claim 1, wherein the polygon further comprises a borderline at the first side, the borderline having a greater density than a non-borderline portion of the polygon.

15. The apparatus of claim 1, wherein the plurality of color marks comprises a plurality of color marks having different colors and same densities in series.

16. The apparatus of claim 1, wherein the polygon is a trapezoid.

17. The apparatus of claim 1, wherein the polygon is a wedge.

18. An apparatus to control both color registration and color toner density at the same time in a color image forming device, said color image forming device having an image carrying member to carry an image having a plurality of colors that moves in a first direction, and perpendicular to a second direction, the apparatus comprising:
a plurality of developing units to form a plurality of color marks formed of respective colors along said first direction, said color marks forming a closed area filled with one of said plurality of colors and comprising a first side which is not parallel to said first and second directions, wherein said respective color toner densities of said plurality of color marks are different; and
a sensing unit comprising:
a sensor to radiate light beams onto said color marks, to receive said light beams reflected from said color marks and to produce detection signals in accordance with the received reflected light beams, and
a control unit to produce color registration offset information and color density offset information from said detection signals.

19. The apparatus of claim 18, wherein said image carrying member comprises first and second margins on opposite sides thereof and said developing units form said color marks along said first and second margins.

20. The apparatus of claim 18, wherein said image forming device further places a background toner pattern having a color other than black on the image carrying member, and the plurality of color marks comprise a mark having a black color.

21. The apparatus of claim 19, wherein said sensor comprises first and second sensors to respectively operate on said color marks formed along said first and second margins.

22. The apparatus of claim 18, wherein the plurality of color marks comprises a plurality of color marks having a same color and different densities in series.

23. The apparatus of claim 18, wherein the color marks each further comprise a second side disposed relative to the first side in the first direction, and the control unit determines an error of the image in the second direction by determining time intervals between the passing of the first and second sides of first and second ones of the color marks on opposite sides of the image carrying member, and subtracting the determined time intervals.

24. The apparatus of claim 18, wherein a power of each of the detection signals rises as the respective color marks approach the sensor, remains constant as the respective color mark pass the sensor, and falls as the respective color marks move away from the sensor, wherein a position W of one of the marks relative to the sensor is determined according to W=T_{width}/2, wherein T_{width} is a time between a middle time of the rising of the power of the respective detection signal and a middle time of the falling of the power of the respective detection signal.

25. The apparatus of claim 24, wherein the light beams have a spot size of less than 200 microns.

26. The apparatus of claim 25, wherein said spot size is less than 100 microns.

27. The apparatus of claim 25, wherein said light beams each have a singular wave.

28. The apparatus of claim 25, wherein said light beams are diffusely radiated.

29. The apparatus of claim 24, wherein the apparatus further comprises a Low Pass Filter to filter noise signals of the detection signals.

30. The apparatus of claim 18, wherein the apparatus is a tandem printer further comprising a plurality of photosensitive drums to respectively form the plurality of colors of the image.

31. The apparatus of claim 18, wherein said control unit comprises an offset calculator to calculate said color registration offset information and said color density offset information.

32. The apparatus of claim 18, wherein the plurality of color marks comprises a plurality of color marks having different colors and same densities in series.

33. A method comprising:
moving an image carrying member to carry an image having a plurality of colors in a first direction;
forming a plurality of polygons on the image carrying member comprising respectively shading in the polygons with toners; and
sensing the polygons to determine an offset of the polygons in the first direction or a second direction perpendicular to the first direction, a skew of the polygons, or an error of the image in the second direction,
the polygons comprising a first side which is not parallel to the first and second directions.

34. The method of claim 33, wherein the forming of the polygons comprises forming the polygons in margin areas of the image carrying member on opposite sides of the image carrying member.

35. The method of claim 33, further comprising forming a background toner pattern having a color other than black on the image carrying member, and the forming of the plurality of polygons comprises forming a polygon having a black color on said background-toner pattern.

36. The method of claim 33, wherein the forming of the polygons comprises forming a plurality of color polygons having a same color and different densities in series.

37. The method of claim 33, wherein the forming of the polygons further comprises forming a second side disposed relative to the first side in the first direction, and the determining of the error of the image in the second direction comprises:
determining time intervals between a passing of the first and second sides of first and second ones of the polygons on opposite sides of the image carrying member, and
subtracting the determined time intervals.

38. The method of claim 33, wherein the sensing comprises using a sensor to detect the polygons, wherein a power of an output of the sensor rises as the polygons respectively approach the sensor, remains constant as the polygons respectively pass the sensor, and falls as the polygons respectively move away from the sensor, the method further comprising:
determining a position W of one of the polygons relative to the sensor according to W=T_{width}/2, wherein T_{width} is a time between a middle time of the rising of the power of the output and a middle time of the falling of the power of the output.

39. The method of claim 38, wherein the sensing further comprises emitting a beam on the polygons to detect the polygons, the beam having a spot size of less than 200 microns.

40. The method of claim 39, wherein the emitting further comprises emitting a beam having a spot size of less than 100 microns.

41. The method of claim 39, wherein the emitting further comprises emitting a beam having a singular wave.

42. The method of claim 39, wherein the emitting further comprises diffusely radiating the beams.

43. The method of claim 38, further comprising filtering noise signals of the output of the sensor with a Low Pass Filter.

44. The method of claim 33, further comprising:
forming a plurality of latent images on a respective plurality of photosensitive drums; and
developing the latent images respectively with the toners.

45. The method of claim 33, wherein the forming of the polygons comprises forming a plurality of color polygons having different colors and a same density in series.

46. In an image forming apparatus having an image carrying member for carrying thereon an image having a plurality of colors, said image carrying member being configured to move in a first direction substantially perpendicular to a second direction, a plurality of color marks having different densities being placed on said image carrying member for controlling respective registrations and the toner densities of said plurality of color marks on said image carrying member, one of said color marks comprising:
a polygon having first and second opposite sides which are not parallel to each other.

47. The apparatus of claim 46, wherein the color marks are placed in margin areas of the image carrying member on opposite sides of the image carrying member.

48. The apparatus of claim 46, wherein said image forming apparatus further places a background toner pattern having a color other than black on the image carrying member, and the plurality of color marks comprise a mark having a black color.

49. The apparatus of claim 46, wherein the plurality of color marks comprises a plurality of color marks having a same color and different densities in series.

50. The apparatus of claim 46, wherein the apparatus further comprises a control unit to determine an error of the image in the second direction by determining time intervals between the passing of the first and second sides of first and second ones of the color marks on opposite sides of the image carrying member, and subtracting the determined time intervals.

51. The apparatus of claim 46, wherein the apparatus further comprises a sensor to detect the color marks, wherein a power of an output of the sensor rises as the color marks respectively approach the sensor, remains constant as the color marks respectively pass the sensor, and fall as the color marks respectively move away from the sensor, wherein a position W the respective marks relative to the sensor is determined according to W=T_{width}/2, wherein T_{width} is a time between a middle time of the rising of the power of the respective output and a middle time of the falling of the power of the respective output.

52. The apparatus of claim 51, wherein the sensor comprises an emitter to emit a beam on the marks to detect the marks, the beam having a spot size of less than 200 microns.

53. The apparatus of claim 52, wherein said spot size is less than 100 microns.

54. The apparatus of claim 52, wherein said emitted beam has a singular wave.

55. The apparatus of claim 52, wherein said emitted beam is diffusely emitted.

56. The apparatus of claim 51, wherein the apparatus further comprises a Low Pass Filter to filter noise signals of the output of the sensor.

57. The apparatus of claim 46, wherein the apparatus is a tandem printer comprising a plurality of photosensitive drums to respectively form the plurality of colors of the image.

58. The apparatus of claim 46, wherein the polygon further comprises borderlines at the first side and second sides, the borderline having a greater density than a non-borderline portion of the polygon.

59. The apparatus of claim 46, wherein the plurality of color marks comprises a plurality of color marks having different colors and same densities in series.

60. The apparatus of claim 46, wherein the polygon is a wedge.

61. The apparatus of claim 46, wherein the polygon is a trapezoid.

62. An apparatus to control both color registration and color toner density at the same time in a color image forming device, said color image forming device having an image carrying member to carry an image having a plurality of colors that moves in a first direction, and perpendicular to a second direction, the apparatus comprising:
a plurality of developing units to form a plurality of color marks formed of respective colors along said first direction, said color marks forming a closed area filled with one of said plurality of colors and comprising first and second opposite sides which are not parallel to each other, wherein respective color toner densities of said plurality of color marks are different; and
a sensing unit comprising:
a sensor to radiate light beams onto said color marks, to receive said light beams reflected from said color marks and to produce detection signals in accordance with the received reflected light beams, and
a control unit to produce color registration offset information and color density offset information from said detection signals.

63. The apparatus of claim 62, wherein said image carrying member comprises first and second margins on opposite sides thereof and said developing units form said color marks along said first and second margins.

64. The apparatus of claim 62, wherein said image forming device further places a background toner pattern having a color other than black on the image carrying member, and the plurality of color marks comprise a mark having a black color.

65. The apparatus of claim 63, wherein said sensor comprises first and second sensors to respectively operate on said color marks formed along said first and second margins.

66. The apparatus of claim 62, wherein the plurality of color marks comprises a plurality of color marks having a same color and different densities in series.

67. The apparatus of claim 62, wherein the control unit determines an error of the image in the second direction by determining time intervals between the passing of the first and second sides of first and second ones of the color marks on opposite sides of the image carrying member, and subtracting the determined time intervals.

68. The apparatus of claim 62, wherein a power of each of the detection signals rises as each of the color marks respectively approach the sensor, remains constant as the color mark respectively pass the sensor, and falls as the color marks respectively move away from the sensor, wherein a position W of one of the marks relative to the sensor is determined according to W=T_{width}/2, wherein T_{width} is a time between a middle time of the rising of the power of the respective detection signal and a middle time of the falling of the power of the respective detection signal.

69. The apparatus of claim 68, wherein the light beams have a spot size of less than 200 microns.

70. The apparatus of claim 69, wherein said spot size is less than 100 microns.

71. The apparatus of claim 69, wherein said light beams each have a singular wave.

72. The apparatus of claim 69, wherein said light beams are diffusely radiated.

73. The apparatus of claim 68, wherein the apparatus further comprises a Low Pass Filter to filter noise signals of the detection signals.

74. The apparatus of claim 62, wherein the apparatus is a tandem printer further comprising a plurality of photosensitive drums to respectively form the plurality of colors of the image.

75. The apparatus of claim 62, wherein said control unit comprises an offset calculator to calculate said color registration offset information and said color density offset information.

76. The apparatus of claim 62, wherein the plurality of color marks comprises a plurality of color marks having different colors and same densities in series.

77. A method comprising:
moving an image carrying member to carry an image having a plurality of colors in a first direction;
forming a plurality of polygons on the image carrying member comprising respectively shading in the polygons with toners; and
sensing the polygons to determine an offset of the polygons in the first direction or a second direction perpendicular to the first direction, a skew of the polygons, or an error of the image in the second direction,
the polygons each comprising first and second opposite sides which are not parallel to each other.

78. The method of claim 77, wherein the forming of the polygons comprises forming the polygons in margin areas of the image carrying member on opposite sides of the image carrying member.

79. The method of claim 77, further comprising forming a background toner pattern having a color other than black on the image carrying member, and the forming of the plurality of polygons comprises forming a polygon having a black color on said background toner pattern.

80. The method of claim 77, wherein the forming of the polygons comprises forming a plurality of color polygons having a same color and different densities in series.

81. The method of claim 77, wherein the determining of the error of the image in the second direction comprises:
determining time intervals between a passing of the first and second sides of first and second ones of the polygons on opposite sides of the image carrying member, and
subtracting the determined time intervals.

82. The method of claim 77, wherein the sensing comprises using a sensor to detect the polygons, wherein a power of an output of the sensor rises as the polygons respectively approach the sensor, remains constant as the polygons respectively pass the sensor, and falls as the polygons respectively move away from the sensor, the method further comprising:
determining a position W the respective polygons relative to the sensor according to W=T_{width}/2, wherein T_{width} is a time between a middle time of the rising of the power of the respective output and a middle time of the falling of the power of the respective output.

83. The method of claim 82, wherein the sensing further comprises emitting a beam on the polygons to detect the polygons, the beam having a spot size of less than 200 microns.

84. The method of claim 83, wherein the emitting further comprises emitting a beam having a spot size of less than 100 microns.

85. The method of claim 83, wherein the emitting further comprises emitting a beam having a singular wave.

86. The method of claim 83, wherein the emitting further comprises diffusely radiating the beams.

87. The method of claim 82, further comprising filtering noise signals of the output of the sensor with a Low Pass Filter.

88. The method of claim 77, further comprising:
forming a plurality of latent images on a respective plurality of photosensitive drums; and
developing the latent images respectively with the toners.

89. The method of claim 77, wherein the forming of the polygons comprises forming a plurality of color polygons having different colors and a same density in series.

90. A method comprising:
moving an image carrying member to carry an image having a plurality of colors in a first direction;
forming a first polygon on the image carrying member; and
determining a color registration error and a density of the first polygon comprising detecting the first polygon.

91. The method of claim 90, wherein the forming of the first polygon comprises forming the first polygon in a first margin area of the image carrying member, the method further comprising forming a second polygon in a second margin area of the image carrying member on an opposite side of the image carrying member from the first margin area.

92. The method of claim 90, further comprising forming a second polygon in series with the first polygon in the first direction, the first and second polygons having a same color and different densities.

93. The method of claim 91, wherein the forming of the polygons comprises forming polygons each having first and second sides disposed relative to each other in the first direction, the method further comprising:
determining an error of the image in a second direction perpendicular to the first direction, comprising:
determining time intervals between a respective passing of the first and second sides of the first and second polygons, and
subtracting the determined time intervals.

94. The method of claim 90, wherein the detecting comprises using a sensor to detect the first polygon, wherein a power of an output of the sensor rises as the first polygon approaches the sensor, remains constant as the first polygon passes the sensor, and falls as the first polygon moves away from the sensor, the method further comprising:
determining a position W of the first polygon relative to the sensor according to W=T_{width}/2, wherein T_{width} is a time between a middle time of the rising of the power of the output and a middle time of the falling of the power of the output.

95. The method of claim 94, wherein the sensing further comprises emitting a beam on the first polygon, the beam having a spot size of less than 200 microns.

96. The method of claim 94, further comprising filtering noise signals of the output of the sensor with a Low Pass Filter.

97. The method of claim 90, further comprising:
forming a plurality of latent images on a respective plurality of photosensitive drums; and
developing the latent images respectively with toners.

98. The method of claim 90, further comprising forming a second polygon in series with the first polygon in the first direction, the first and second polygons having a different colors and same densities.
